(19) United States
(12) Patent Application Publication
(10) Pub. No.: US 2026/0229606 A1
(43) Pub. Date: Aug. 6, 2026

(54) LITHIUM-ION SECONDARY BATTERY

(71) Applicant: HONDA MOTOR CO., LTD., Tokyo (JP)

(72) Inventor: Toshiyuki ARIGA, Saitama (JP)

(21) Appl. No.: 19/530,359

(22) Filed: Feb. 5, 2026

(30) Foreign Application Priority Data
Feb. 6, 2025 (JP) 2025-018710

(51) Int. Cl. H01M 10/0585; H01M 4/13; H01M 4/66; H01M 10/0525; H01M 50/531

(52) U.S. Cl. CPC H01M 10/0585; H01M 4/13; H01M 4/665; H01M 10/0525; H01M 50/531

(57) ABSTRACT

A lithium-ion secondary battery includes a stacked body in which a negative electrode including lithium and a positive electrode are stacked with an electrolyte therebetween. The positive electrode includes a positive-electrode current collector foil and a positive-electrode active material layer stacked on the positive-electrode current collector foil. The positive-electrode current collector foil includes: a positive-electrode active material layer forming portion in which the positive-electrode active material layer is formed; a current-collector exposed portion adjacent to the positive-electrode active material layer forming portion and having a surface of the positive-electrode current collector foil exposed; and a current-collector tab portion disposed on a side opposite to the positive-electrode active material layer forming portion across the current-collector exposed portion and located at an end portion of the positive-electrode current collector foil. An insulating member is disposed so as to cover a surface and an end portion of the current-collector exposed portion.

This application is based on and claims the benefit of priority from Japanese Patent Application No. 2025-018710, filed on 6 February 2025, the content of which is incorporated herein by reference.

### BACKGROUND OF THE INVENTION

### Field of the Invention

The present invention relates to a lithium-ion secondary battery.

### Related Art

Conventionally, as for a lithium secondary battery, a technique is known in which a stacked body is configured with a negative electrode including lithium and a positive electrode including a positive-electrode current collector foil and a positive-electrode composite layer. An example of a document disclosing such a technique is Japanese Unexamined Patent Application, Publication No. 2010-055906.

Japanese Unexamined Patent Application, Publication No. 2010-055906 relates to a non-aqueous electrolyte secondary battery. In Japanese Unexamined Patent Application, Publication No. 2010-055906, a positive-electrode plate of the non-aqueous electrolyte secondary battery includes a collector tab, an exposed portion of a metal foil, and a surface of a positive-electrode active material layer adjacent to the exposed portion of the metal foil covered with an insulating tape, and the insulating tape includes an adhesive-layer-formed region and an adhesive-layer-unformed region. The surface of the positive-electrode active material layer is covered in the adhesive-layer-unformed region of the insulating tape.

Patent Document 1: Japanese Unexamined Patent Application, Publication No. 2010-055906

### SUMMARY OF THE INVENTION

Meanwhile, heat generation during battery use may cause malfunctions. For example, in a lithium secondary battery in which a separator is disposed between a positive electrode and a negative electrode, when the temperature rises to approximately 150°C, thermal shrinkage of the separator may occur, leading to short-circuiting between the positive electrode and the negative electrode due to breakage or deformation of the separator. When a temperature near the positive-electrode current collector foil reaches approximately 180°C, molten lithium flows and may come into contact with the positive-electrode current collector foil, causing a low-resistance short circuit.

By disposing an insulating member, it is possible to prevent short-circuiting caused by separator breakage at high temperature or impacts from outside. However, since a current-collector tab portion of the positive-electrode current collector foil is narrower than a portion where a positive-electrode active material layer is formed, it is difficult to secure a sufficiently large adhesion area for the insulating member on a current-collector tab portion side. Therefore, the insulating member may peel off from the positive-electrode current collector foil due to contact with a separator damaged by an external impact or abnormal heat generation. Thus, in terms of preventing peeling of the insulating member, there was room for improvement in the conventional technology.

An object of the present invention is to provide a lithium-ion secondary battery capable of securing a sufficient adhesion area for adhering an insulating member to a positive-electrode current collector foil so as to prevent short-circuiting of the positive-electrode current collector foil.

(1) The present invention relates to a lithium-ion secondary battery (for example, a lithium-ion secondary battery 1 described later) including a stacked body (for example, a stacked body 10 described later) in which a negative electrode including lithium (for example, a negative electrode 20 described later) and a positive electrode (for example, a positive electrode 40 described later) are stacked with an electrolyte (for example, an electrolyte 30 described later) therebetween. The positive electrode includes a positive-electrode current collector foil (for example, a positive-electrode current collector foil 41 described later) and a positive-electrode active material layer (for example, a positive-electrode active material layer 42 described later) stacked on the positive-electrode current collector foil. The positive-electrode current collector foil includes: a positive-electrode active material layer forming portion (for example, a positive-electrode active material layer forming portion 410 described later) in which the positive-electrode active material layer is formed; a current-collector exposed portion (for example, a current-collector exposed portion 411 described later) adjacent to the positive-electrode active material layer forming portion and having a surface of the positive-electrode current collector foil exposed; and a current-collector tab portion (for example, a current-collector tab portion 412 described later) disposed on a side opposite to the positive-electrode active material layer forming portion across the current-collector exposed portion and located at an end portion of the positive-electrode current collector foil. An insulating member (for example, an insulating member 60 or 160 described later) is disposed so as to cover a surface and an end portion of the current-collector exposed portion.

(2) The lithium-ion secondary battery as described in item (1), further including a separator (for example, a separator 50 described later) disposed between the negative electrode and the positive electrode. In a predetermined direction in which the current-collector tab portion, the current-collector exposed portion, and the positive-electrode active material layer forming portion are arranged, when a side of the current-collector tab portion of the positive-electrode current collector foil is defined as an outer side, and a side of the positive-electrode active material layer forming portion is defined as an inner side, an outer end portion of the insulating member in the predetermined direction is positioned farther outward than an outer end portion of the separator and positioned farther inward than an end portion of the current-collector tab portion on a side opposite to the positive-electrode active material layer forming portion.

(3) The lithium-ion secondary battery as described in item (1), further including a separator (for example, a separator 50 described later) disposed between the negative electrode and the positive electrode. In a predetermined direction in which the current-collector tab portion, the current-collector exposed portion, and the positive-electrode active material layer forming portion are arranged, when a side of the current-collector tab portion of the positive-electrode current collector foil is defined as an outer side, and a side of the positive-electrode active material layer forming portion is defined as an inner side, the current-collector exposed portion is disposed farther inward than an outer end portion of the separator in the predetermined direction and has a width equal to a width of the positive-electrode active material layer forming portion.

(4) The lithium-ion secondary battery as described in any one of items (1) to (3), in which a volume resistivity of the insulating member is 1×10¹⁵ Ωcm or more.

(5) The lithium-ion secondary battery as described in any one of items (1) to (4), in which the volume resistivity of the insulating member is 1×10²⁰ Ωcm or less.

(6) The lithium-ion secondary battery as described in any one of items (1) to (5), in which a thickness of the insulating member is between 5µm and 100µm inclusive.

(7) The lithium-ion secondary battery as described in any one of items (1) to (6), in which the positive-electrode current collector foil is a composite current-collector foil.

(8) The lithium-ion secondary battery as described in any one of items (1) to (7), in which the insulating member has heat-resistant adhesiveness.

(9) The lithium-ion secondary battery as described in any one of items (1) to (7), in which the insulating member has thermal fusibility.

(10) The lithium-ion secondary battery as described in any one of items (1) to (9), further including a separator (for example, a separator 50 described later) disposed between the negative electrode and the positive electrode, in which a conductive layer (for example, a conductive layer 51 described later) is formed on a negative-electrode side of the separator.

According to the present invention, it is possible to provide a lithium-ion secondary battery capable of securing a sufficient adhesion area for adhering an insulating member to a positive-electrode current collector foil so as to prevent short-circuiting of the positive-electrode current collector foil.

### BRIEF DESCRIPTION OF THE DRAWINGS

FIG. 1 is a conceptual cross-sectional view illustrating a configuration of a lithium-ion secondary battery according to an embodiment of the present invention;

FIG. 2 is an enlarged cross-sectional view illustrating a positional relationship between a positive electrode and an insulating member in the lithium-ion secondary battery of the present embodiment;

FIG. 3 is a perspective view illustrating a positional relationship between the positive electrode and the insulating member in the lithium-ion secondary battery of the present embodiment;

FIG. 4 is a perspective view illustrating a positional relationship between a positive electrode and an insulating member in a lithium-ion secondary battery of a comparative example; and

FIG. 5 is a perspective view illustrating a positional relationship between a positive electrode and an insulating member in a lithium-ion secondary battery of a modified example.

### DETAILED DESCRIPTION OF THE INVENTION

Hereinafter, an embodiment of the present invention will be described in detail with reference to the drawings.

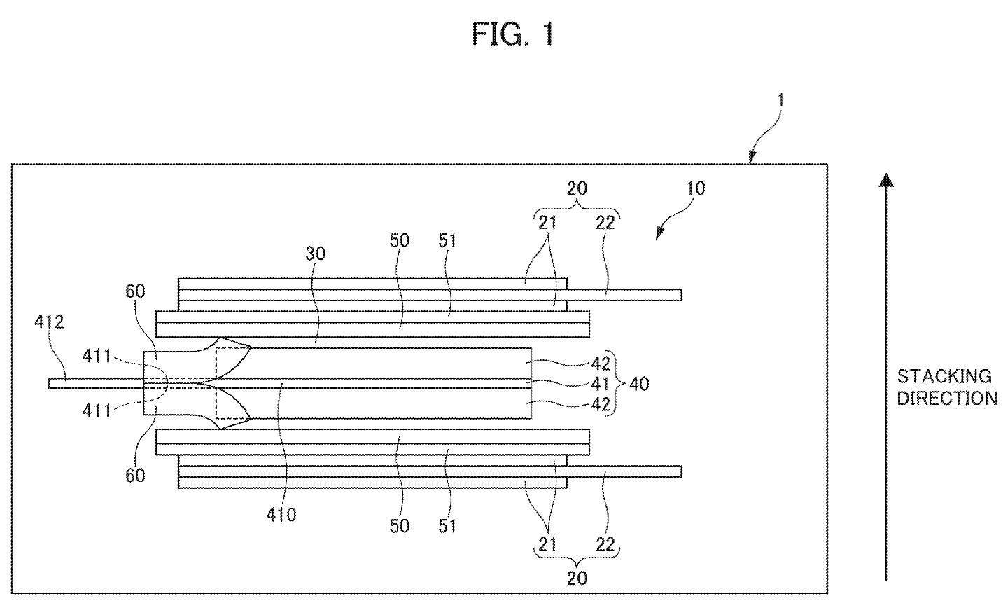

FIG. 1 is a conceptual cross-sectional view illustrating a configuration of a lithium-ion secondary battery 1 according to an embodiment of the present invention. The lithium-ion secondary battery 1 of the present embodiment includes a stacked body 10. The stacked body 10 includes a negative electrode 20, an electrolyte 30, a positive electrode 40, a separator 50, and an insulating member 60. In the following description, a direction in which respective components of the stacked body 10 are stacked is referred to as a stacking direction.

A positional relationship among the respective components of the stacked body 10 will be described. The positional relationship among the components constituting the stacked body 10 is such that the negative electrode 20, the electrolyte 30, and the positive electrode 40 are arranged in this order in the stacking direction. The separator 50 is disposed between the negative electrode 20 and the positive electrode 40. The insulating member 60 is positioned between the separator 50 and the separator 50.

The negative electrode 20 includes lithium. The negative electrode 20 includes a negative-electrode active material layer 21 and a negative-electrode current collector layer 22. The negative-electrode active material layer 21 is formed on each of both surfaces of the negative-electrode current collector layer 22, the surfaces facing in the stacking direction. In the stacking direction, the entire surface of the negative-electrode active material layer 21 on a side opposite to the negative-electrode current collector layer 22 faces a conductive layer 51 of the separator 50 described later.

The negative-electrode active material layer 21 is not particularly limited and is formed from known negative-electrode active materials used for negative-electrode active material layers. From the viewpoint of improving energy density of the lithium-ion secondary battery 1, it is preferable that the negative-electrode active material layer 21 be a lithium metal layer in which the negative-electrode active material is lithium metal. The lithium metal includes lithium alloys, in addition to lithium metal itself. The negative-electrode active material layer 21 may alternatively be formed from silicon-based active materials such as Si and Si alloys, lithium transition-metal oxides such as lithium titanium oxide (Li₄Ti₅O₁₂), transition-metal oxides such as TiO₂, Nb₂O₃, and WO₃, metal sulfides, metal nitrides, carbon materials such as graphite, soft carbon, and hard carbon, and metal indium.

The negative-electrode current collector layer 22 is not particularly limited and may be formed from copper, nickel, or stainless steel. Examples of shapes of the negative-electrode current collector layer 22 include foil, plate, mesh, non-woven fabric, and foam.

The electrolyte 30 is a source of lithium ions, which are charge-transfer media, and includes a lithium salt. Examples of the lithium salt include LiPF₆, LiBF₄, LiClO₄, LiAsF₆, LiCF₃SO₃, LiC(CF₃SO₂)₃, LiN(CF₃SO₂)₂ (LiTFSI), LiN(FSO₂)₂ (LiFSI), and LiBC₄O₈. A single lithium salt may be used alone, or two or more lithium salts may be used in combination.

The electrolyte 30 exists as an electrolytic solution containing an organic solvent. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. A single organic solvent may be used alone, or two or more organic solvents may be used in combination.

A solid electrolyte may also be used as the electrolyte 30. In this case, the electrolyte 30 is stacked between the positive electrode 40 and the negative electrode 20. As the solid electrolyte, any material having lithium-ion conductivity may be used without particular limitation, and examples thereof include oxide electrolytes and sulfide electrolytes.

The positive electrode 40 includes a positive-electrode current collector foil 41 and a positive-electrode active material layer 42. The positive-electrode active material layer 42 is formed on each of both surfaces of the positive-electrode current collector foil 41, the surfaces facing in the stacking direction.

A material for the positive-electrode current collector foil 41 is not particularly limited and is formed from known current-collecting materials used for positive-electrode current collectors in lithium secondary batteries. For example, the positive-electrode current collector foil 41 may be formed from a known composite current-collector foil including a metal such as aluminum and a resin layer such as polyethylene, polypropylene, or polyethylene terephthalate. The positive-electrode current collector foil 41 is not limited to a composite current-collector foil and may be a single metal foil such as an aluminum foil.

The positive-electrode active material layer 42 is formed on the positive-electrode current collector foil 41. In the present embodiment, the surface of the positive-electrode active material layer 42 opposite to the surface facing the positive-electrode current collector foil 41 in the stacking direction faces the separator 50.

The positive-electrode active material layer 42 includes a positive-electrode active material, and may further include a conductive additive, a binder, and the like. The positive-electrode active material is not particularly limited as long as it can intercalate and release lithium ions, and examples thereof include lithium nickel cobalt manganese composite oxides. As the solid electrolyte, any material having lithium-ion conductivity may be used without particular limitation, and examples thereof include oxide electrolytes and sulfide electrolytes. The conductive additive is not particularly limited as long as it has electronic conductivity, and examples thereof include carbon black. The binder is not particularly limited as long as it can improve binding properties, and examples thereof include styrene-butadiene rubber.

The separator 50 may include a conductive layer 51. The conductive layer 51 is stacked on the separator 50. The conductive layer 51 is formed on a surface of the separator 50 opposite to a side facing the positive-electrode active material layer 43, that is, on a side facing the negative electrode 20. A material for the conductive layer 51 is not particularly limited, and examples thereof include carbon materials such as carbon black and carbon nanotubes, and materials containing metals such as copper.

A material for the separator 50 is not particularly limited, and examples thereof include porous sheets and non-woven fabric sheets. Examples of materials for the porous sheet include polyolefins such as polyethylene and polypropylene, aramid, polyimide, and fluorocarbon resins. Examples of materials for the non-woven fabric sheet include glass fiber and cellulose fiber.

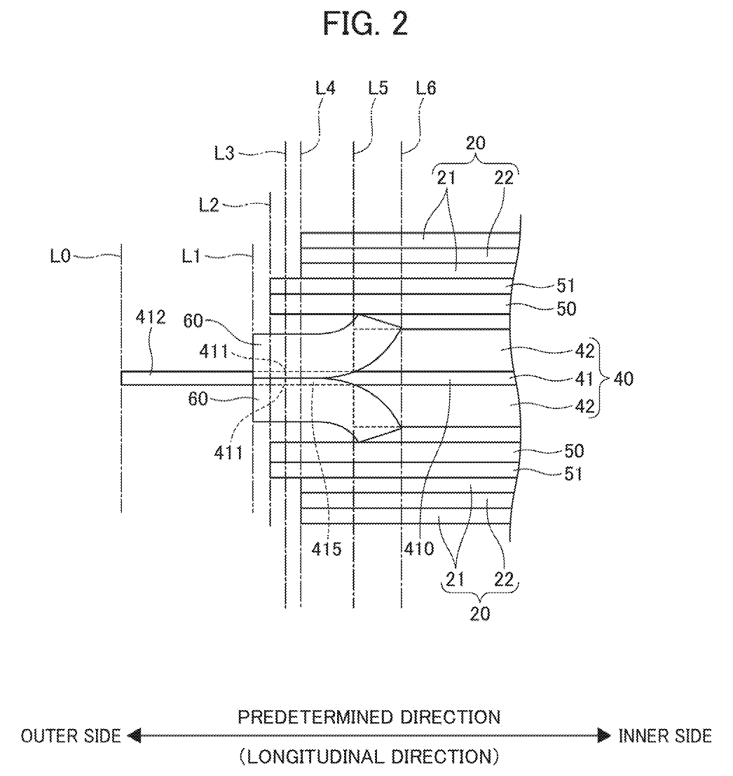

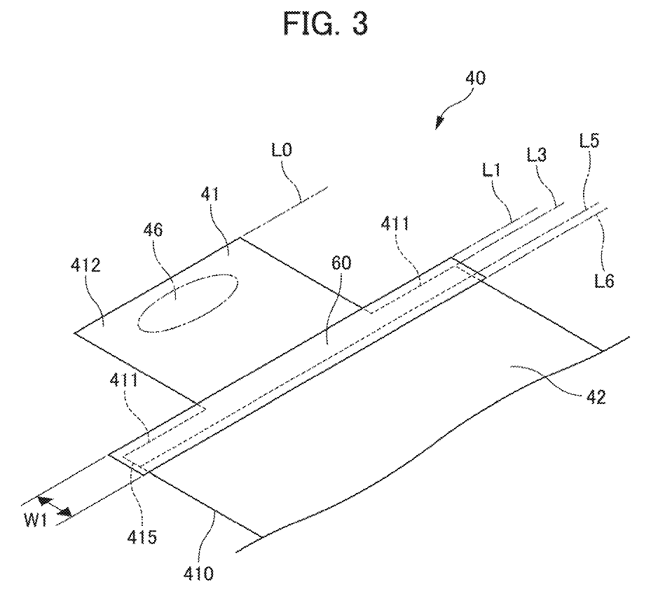

Next, the insulating member 60 will be described. First, with reference to FIG. 2 and FIG. 3, a positional relationship of the insulating member 60 will be described. FIG. 2 is an enlarged cross-sectional view illustrating a positional relationship between the positive electrode 40 and the insulating member 60 in the lithium-ion secondary battery 1 of the present embodiment. FIG. 3 is a perspective view illustrating a positional relationship between the positive electrode 40 and the insulating member 60 in the lithium-ion secondary battery 1 of the present embodiment.

First, a configuration of the positive-electrode current collector foil 41 on which the insulating member 60 is disposed will be described. The positive-electrode current collector foil 41 is formed to be elongated in a predetermined direction. As illustrated in FIG. 2 and FIG. 3, the positive-electrode current collector foil 41 has three regions: a positive-electrode active material layer forming portion 410, a current-collector exposed portion 411, and a current-collector tab portion 412. The positive-electrode active material layer forming portion 410, the current-collector exposed portion 411, and the current-collector tab portion 412 are arranged in the predetermined direction of the positive-electrode current collector foil 41. In FIG. 2, a side of the predetermined direction in which the current-collector tab portion 412 of the positive-electrode current collector foil 41 is formed may be defined as an outer side, and a side of the predetermined direction in which the positive-electrode active material layer forming portion 410 is formed may be defined as an inner side. The predetermined direction is not particularly limited, but in the present embodiment corresponds to a longitudinal direction of the positive-electrode current collector foil 41.

The positive-electrode active material layer forming portion 410 is a positive-electrode active material layer coating portion on which the positive-electrode active material layer 42 is stacked. Since the positive-electrode active material layer 42 is stacked on the positive-electrode active material layer forming portion 410, the positive-electrode active material layer forming portion 410 is located on a rear side of the positive-electrode active material layer 42 as viewed in the stacking direction, and is thus not visible from outside. The positive-electrode active material layer forming portion 410 is formed on each of both surfaces of the positive-electrode current collector foil 41, the surfaces facing in the stacking direction.

The current-collector exposed portion 411 is a region adjacent to the positive-electrode active material layer forming portion 410 and is a region in which the positive-electrode active material layer 42 is not formed. Since the positive-electrode active material layer 42 is not stacked on the current-collector exposed portion 411, the current-collector exposed portion 411 is exposed externally, as viewed in the stacking direction. The width of the current-collector exposed portion 411 in a direction orthogonal to the predetermined direction (width direction) is equal to the width of the positive-electrode active material layer forming portion 410 in the direction orthogonal to the predetermined direction (width direction), and end surfaces of the current-collector exposed portion 411 and the positive-electrode active material layer forming portion 410 are continuous in the longitudinal direction. The current-collector exposed portion 411 is formed on each of both surfaces of the positive-electrode current collector foil 41 that face in the stacking direction.

The current-collector tab portion 412 is a region formed at an end portion on one side in the longitudinal direction of the positive-electrode current collector foil 41 and is adjacent to the current-collector exposed portion 411. The current-collector tab portion 412 is disposed on a side opposite to the positive-electrode active material layer forming portion 410 across the current-collector exposed portion 411 in the predetermined direction. The width of the current-collector tab portion 412 in a direction orthogonal to the predetermined direction is narrower than the width of the current-collector exposed portion 411 or the positive-electrode active material layer forming portion 410 in the direction, orthogonal to the predetermined direction and is convex when viewed in the stacking direction. A joining portion 46 indicated by the chain line is formed in the current-collector tab portion 412, and a lead tab (not illustrated) is joined through the joining portion 46.

The insulating member 60 is disposed so as to cover the entire surface region of the current-collector exposed portion 411. Together with the current-collector exposed portion 411, the insulating member 60 is set to have a predetermined-direction length W1 n so as to cover part of an inner side an inner-side portion of the current-collector tab portion 412 and part of the positive-electrode active material layer forming portion 410. The predetermined-direction length W1 of the insulating member 60 is set so as not to overlap the joining portion 46 formed on an outer side of the current-collector tab portion 412.

Further, the insulating member 60 covers at least part of the current-collector tab portion 412 and an end portion 415 of the current-collector exposed portion 411. The end portion 415 of the current-collector exposed portion 411 is a portion including an end surface (side surface) of the current-collector exposed portion 411 that faces in a direction orthogonal to the predetermined direction. The insulating member 60 may be configured to cover not only the current-collector exposed portion 411 but also part of an end surface of the current-collector tab portion 412 and part of an end surface of the positive-electrode active material layer forming portion 410.

With reference to imaginary lines L0 to L5 indicated by the chain lines in FIG. 2, a positional relationship of the positive-electrode active material layer forming portion 410, the current-collector exposed portion 411, the current-collector tab portion 412, and the insulating member 60 in the predetermined direction will be described. In FIG. 2, the imaginary line L0 indicates a position of an outer end portion of the current-collector tab portion 412 in the predetermined direction. The imaginary line L1 indicates a position of an outer end portion of the insulating member 60 in the predetermined direction. The imaginary line L2 indicates a position of an outer end portion of the separator 50 in the predetermined direction. The imaginary line L3 indicates a position of an inner end portion of the current-collector tab portion 412 in the predetermined direction and a position of an outer end portion of the current-collector exposed portion 411 in the predetermined direction. The imaginary line L4 indicates a position of an outer end portion of the negative electrode 20 (the negative-electrode active material layer 21 and the negative-electrode current collector layer 22) in the predetermined direction. The imaginary line L5 indicates a position of an inner end portion of the current-collector exposed portion 411 in the predetermined direction and a position of an outer end portion of the positive-electrode active material layer forming portion 410 (the positive-electrode active material layer 42) in the predetermined direction. The imaginary line L6 indicates a position of an inner end portion of the insulating member 60 in the predetermined direction.

As indicated by the imaginary lines L0 and L1, an outer end portion of the insulating member 60 in the predetermined direction is positioned farther inward than the outer end portion of the current-collector tab portion 412. As indicated by the imaginary lines L1 and L2, the outer end portion of the insulating member 60 in the predetermined direction is positioned farther outward than an end portion of the separator 50.

As indicated by the imaginary lines L2 and L3, an outer end portion of the current-collector exposed portion 411 in the predetermined direction is positioned farther inward than the outer end portion of the separator 50. As indicated by the imaginary lines L3 and L4, the outer end portion of the current-collector exposed portion 411 in the predetermined direction is positioned farther outward than the outer end portion of the negative electrode 20.

As indicated by the imaginary lines L4 and L5, an outer end portion of the positive-electrode active material layer forming portion 410 in the predetermined direction is positioned farther inward than the outer end portion of the negative electrode 20. Further, as indicated by the imaginary lines L5 and L6, an inner end portion of the insulating member 60 in the predetermined direction is positioned farther inward than the outer end portion of the positive-electrode active material layer forming portion 410.

Physical properties of the insulating member 60 will be described. The insulating member 60 is formed in a thin-film tape shape. From the viewpoint of effectively preventing short-circuiting of the positive-electrode current collector foil, it is preferable that a thickness of the insulating member 60 be between 5µm and 100µm inclusive. A thickness of the insulating member 60 may also be defined based on a thickness of the positive-electrode active material layer 42. For example, it is preferable that the thickness of the insulating member 60 be between 5% and 30% inclusive of a total of the thickness of the positive-electrode active material layer 42 and a thickness of the separator 50, and more preferably between 10% and 20% inclusive. This suppresses an increase in an overall battery thickness due to the thickness of the insulating member and enables more effective prevention of short-circuiting of the positive-electrode current collector foil. It is preferable that the insulating member 60 have a volume resistivity of 1×10¹⁵ Ωcm or more; and without particular limitation, the upper limit of the volume resistivity may be, for example, 1×10²⁰ Ωcm or less.

The insulating member 60 is formed from a resin film having thermal fusibility. Examples of the resin include known resins such as polyethylene, polypropylene, polyethylene terephthalate, and polyimide. From the viewpoint of heat resistance, polyimide is preferable. The insulating member 60 has an adhesive surface and is adhered to the positive-electrode current collector foil 41. A Kapton® tape may be used as the insulating member 60.

An example of a method for manufacturing the lithium-ion secondary battery 1 will be described. First, a step of disposing the positive-electrode current collector foil 41 is performed, in which the positive-electrode current collector foil 41 includes a current-collector exposed portion 411 extended with a width equal to a width of the positive-electrode active material layer forming portion 410, which is a portion where the positive-electrode active material layer 42 is formed, and the current-collector tab portion 412 is formed adjacent to the current-collector exposed portion 411. In the step of disposing the positive-electrode current collector foil 41, lengths (sizes) and arrangement positions of the positive-electrode current collector foil 41 and the separator 50 are adjusted so that an outer end portion of the current-collector exposed portion 411 in the predetermined direction is positioned farther inward than an outer end portion of the separator 50.

Next, a step is performed in which the insulating member 60 is disposed on both surfaces of the positive-electrode current collector foil 41. In this step, the insulating member 60 is fixed to the positive-electrode current collector foil 41 so as to cover end surfaces of the current-collector exposed portion 411, the current-collector tab portion 412, and the positive-electrode active material layer forming portion 410. In the configuration in which the insulating member 60 is disposed on the positive-electrode current collector foil 41, lengths (sizes) and arrangement positions of the insulating member 60 are adjusted so that an outer end portion of the insulating member 60 in the predetermined direction protrudes outward beyond an outer end portion of the separator 50.

By including these steps, it is possible to manufacture the lithium-ion secondary battery 1 in which an adhesion area of the insulating member 60, as described with reference to FIG. 1 to FIG. 3, can be secured.

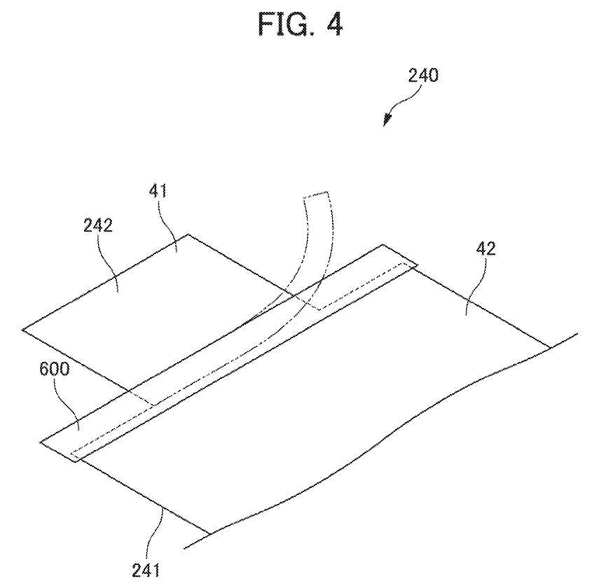

Next, with reference to FIG. 4, comparative examples will be described to explain effects of the lithium-ion secondary battery 1 of the present embodiment. Components common or similar to those of the above embodiment are denoted by the same reference numerals, and detailed description thereof is omitted.

FIG. 4 is a perspective view illustrating a positional relationship between a positive electrode 240 and an insulating member 600 in a lithium-ion secondary battery of a comparative example. As illustrated in FIG. 4, the positive electrode 240 of the comparative example includes a positive-electrode active material layer forming portion 241 and a current-collector tab portion 242, and unlike the lithium-ion secondary battery 1 of the above embodiment, does not include the current-collector exposed portion 411. The positive-electrode active material layer forming portion 241 and the current-collector tab portion 242 are arranged adjacent to each other.

In the comparative example, the insulating member 600 is adhered so as to cover part of an outer-side portion in the predetermined direction of the positive-electrode active material layer 42 stacked on the positive-electrode active material layer forming portion 241 and part of an inner side of the current-collector tab portion 242. Even in the comparative example, short-circuiting between the current-collector tab portion 242 and the negative electrode 20 side can be prevented by the insulating member 600.

However, the width of the current-collector tab portion 242 in a direction orthogonal to the predetermined direction is narrower than the width of the positive-electrode active material layer forming portion 241. Therefore, the insulating member 600 of the comparative example cannot secure a sufficient adhesion area in the direction orthogonal to the predetermined direction of the current-collector tab portion 242. As indicated by the chain line in FIG. 4, the insulating member 600 is likely to peel off, and there is a concern that the insulating member 600 may peel during battery use and the current-collector tab portion 242 may short-circuit with the negative electrode 20 side.

Since the insulating member 600 is adhered in a manner that causes the insulating member 600 to ride directly from the current-collector tab portion 242 onto the thick positive-electrode active material layer 42, an end portion of the insulating member 600 turns upward, thereby creating a step on a surface of the positive-electrode active material layer 42. Since the positive electrode 240 is constrained in the stacking direction by components such as the separator 50 (not illustrated in FIG. 4), uniform pressure is not applied at the stepped portion. Due to the loss of uniform pressure, deposition of lithium becomes concentrated at the stepped portion, resulting in a non-uniform deposition reaction and causing deterioration of battery life. Thus, in the configuration of the comparative example, non-uniform deposition of lithium is more likely to occur.

In this regard, the lithium-ion secondary battery 1 of the present embodiment is configured as follows. That is, the lithium-ion secondary battery 1 includes the stacked body 10 in which the negative electrode 20 including lithium and the positive electrode 40 are stacked with the electrolyte 30 therebetween. The positive electrode 40 includes: the positive-electrode current collector foil 41; and the positive-electrode active material layer 42 stacked on the positive-electrode current collector foil 41. The positive-electrode current collector foil 41 includes: the positive-electrode active material layer forming portion 410 in which the positive-electrode active material layer 42 is formed; the current-collector exposed portion 411 adjacent to the positive-electrode active material layer forming portion 410 and having a surface of the positive-electrode current collector foil 41 exposed; and the current-collector tab portion 412 disposed on a side opposite to the positive-electrode active material layer forming portion 410 across the current-collector exposed portion 411 and located at an end portion of the positive-electrode current collector foil 41. The insulating member 60 is disposed so as to cover the surface and the end portion 415 of the current-collector exposed portion 411.

Accordingly, the current-collector exposed portion 411 serves as a support for adhering the insulating member 60, enabling the adhesion area of the insulating member 60 to be secured larger than in the configuration of the comparative insulating member 600. Since the insulating member 60 is adhered in a manner that rides from the current-collector tab portion 412 onto the positive-electrode active material layer 42 through the current-collector exposed portion 411, an angle of an end portion of the insulating member 60 on the current-collector exposed portion 411 becomes gentler (relatively downward) compared with the comparative example, thereby suppressing non-uniform lithium deposition caused by a step on the positive-electrode active material layer 42. Since a portion of the positive-electrode current collector foil 41 of the positive electrode 40 on which the positive-electrode active material layer 42 is not stacked and the end portion 415 are covered by the insulating member 60 and the positive-electrode current collector foil 41 is not exposed, even if thermal shrinkage of the separator 50 occurs due to abnormal heat generation, short-circuiting between an exposed portion of the positive-electrode current collector foil 41 and the negative electrode 20 can be prevented. That is, both functions of preventing non-uniform deposition of lithium and preventing short-circuiting can be achieved simultaneously.

The lithium-ion secondary battery 1 of the present embodiment further includes the separator 50 disposed between the negative electrode 20 and the positive electrode 40. In a predetermined direction (longitudinal direction) in which the current-collector tab portion 412, the current-collector exposed portion 411, and the positive-electrode active material layer forming portion 410 are arranged, when a side of the current-collector tab portion 412 of the positive-electrode current collector foil 41 is defined as an outer side and a side of the positive-electrode active material layer forming portion 410 is defined as an inner side, an outer end portion of the insulating member 60 in the predetermined direction is positioned farther outward than an outer end portion of the separator 50 and positioned farther inward than an end portion of the current-collector tab portion 412 on a side opposite to the positive-electrode active material layer forming portion 410.

Accordingly, while securing joining at the joining portion 46 on the current-collector tab portion 412, a region of the insulating member 60 positioned farther outward than the separator 50 can be widened, making it possible to more reliably prevent occurrence of short-circuiting caused by thermal shrinkage of the separator 50 during abnormal heat generation or breakage caused by impacts.

The lithium-ion secondary battery 1 of the present embodiment further includes the separator 50 disposed between the negative electrode 20 and the positive electrode 40. In a predetermined direction in which the current-collector tab portion 412, the current-collector exposed portion 411, and the positive-electrode active material layer forming portion 410 are arranged, when a side of the current-collector tab portion 412 of the positive-electrode current collector foil 41 is defined as an outer side and a side of the positive-electrode active material layer forming portion 410 is defined as an inner side, the current-collector exposed portion 411 is disposed farther inward than the outer end portion of the separator 50 in the predetermined direction and has a width equal to a width of the positive-electrode active material layer forming portion 410.

The separator 50 damaged by an external impact or the like may damage the insulating member 60, or the current-collector exposed portion 411 may be bent during collection and break through the insulating member 60. In such cases, if the current-collector exposed portion 411 protrudes outward of the separator 50, short-circuiting is likely to occur between the negative electrode 20 or the conductive layer 51 of the separator 50 and the current-collector exposed portion 411. In this regard, in the configuration of the present embodiment, since the current-collector exposed portion 411 is positioned farther inward than the separator 50, short-circuiting of the current-collector exposed portion 411 can be avoided even when the insulating member 60 is damaged. Since the width of the current-collector exposed portion 411 is equal to the width of the positive-electrode active material layer forming portion 410, the adhesion area of the insulating member 60 can be secured to be large without complicated processing. Furthermore, as in the present embodiment, by positioning an outer end portion of the current-collector exposed portion 411 farther outward than the negative electrode 20, it is possible to increase the adhesion area as much as possible while suppressing short-circuiting caused by damage to the insulating member 60.

A volume resistivity of the insulating member 60 of the present embodiment may be 1×10¹⁵ Ωcm or more. This allows the insulating member 60 to appropriately exhibit its insulating function. An upper limit of the volume resistivity of the insulating member 60 of the present embodiment is not particularly limited, but may be 1×10²⁰ Ωcm or less.

A thickness of the insulating member 60 of the present embodiment may be between 5µm and 100µm inclusive. Accordingly, a lithium secondary battery having a good insulating function can be achieved without adversely affecting a restraining force due to the thickness of the insulating member 60. It is preferable that the thickness of the insulating member 60 be between 5µm and 100µm inclusive, more preferably between 5µm and 50µm inclusive, and particularly preferably between 5µm and 30µm inclusive.

The positive-electrode current collector foil 41 of the present embodiment may be a composite current-collector foil. By using a composite current-collector foil including a resin, short-circuiting during abnormal heat generation can be more reliably prevented since the resin in the positive-electrode current collector foil 41 melts and interrupts a conductive path during abnormal heat generation.

The insulating member 60 of the present embodiment may have heat-resistant adhesiveness. Accordingly, a situation in which an adhesive melts during heat generation and the insulating member 60 peels from the positive-electrode current collector foil 41 can be avoided.

The insulating member 60 of the present embodiment may have thermal fusibility. Accordingly, the insulating member 60 can be fixed to the positive-electrode current collector foil 41 by thermal fusion bonding through heating such as heat pressing.

The lithium-ion secondary battery 1 of the present embodiment further includes the separator 50 disposed between the negative electrode 20 and the positive electrode 40, and the conductive layer 51 is formed on the negative-electrode 20 side of the separator 50. Accordingly, by using the separator 50 together with the insulating member 60, short-circuiting due to contact between the positive electrode 40 and the negative electrode 20 can be more reliably prevented. Even if the separator 50 is damaged and a portion of the conductive layer 51 attempts to contact the current-collector exposed portion 411, short-circuiting can be prevented by the insulating member 60.

Next, a modified example of the lithium-ion secondary battery 1 of the above embodiment will be described. In the following description, components common or similar to those described in the above embodiment are denoted by the same reference numerals, and detailed description thereof may be omitted.

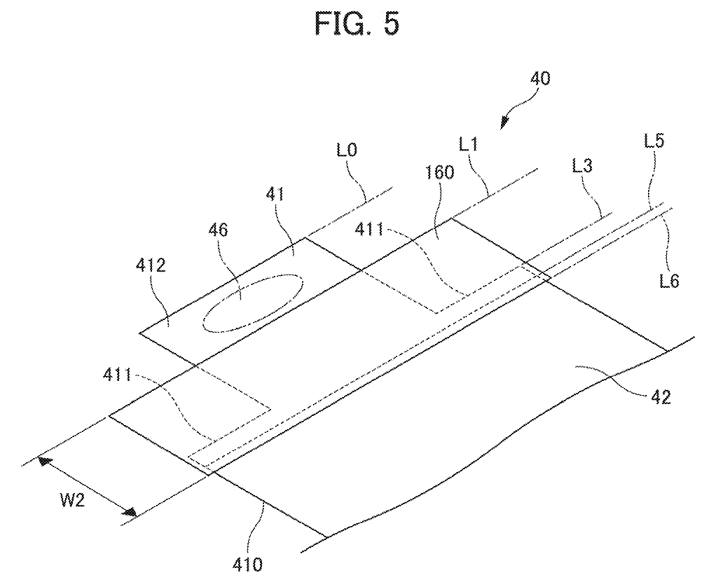

FIG. 5 is a perspective view illustrating a positional relationship between the positive electrode 40 and an insulating member 160 in the lithium-ion secondary battery 1 of the modified example. In the following description of the modified example, components other than the insulating member 160 are regarded as being common to those of the above embodiment.

In the modified example, a predetermined-direction length W2 of the insulating member 160 is set to be longer than a predetermined-direction length W1 of the insulating member 60 of the above embodiment. Accordingly, an adhesion area of the insulating member 160 on the current-collector tab portion 412 is larger than that in the above embodiment. The predetermined-direction length W2 of the insulating member 160 is set so as to extend to a vicinity of the joining portion 46. As described above, the insulating member 160 may be extended to a location near the joining portion 46. This makes it possible to provide insulation over a wider range by using the insulating member 160 having a greater predetermined-direction length.

Although the embodiment of the present invention has been described above, the present invention is not limited to the above embodiment and may be modified as appropriate within the scope of the spirit of the present invention. For example, in the above embodiment, the positive-electrode active material layer forming portion 410, the current-collector exposed portion 411, and the current-collector tab portion 412 are disposed on both surfaces of the positive-electrode current collector foil 41, and the insulating member 60 is disposed on each of the both surfaces. However, the configuration is not limited thereto. A configuration may be adopted in which the positive-electrode active material layer forming portion 410, the current-collector exposed portion 411, and the current-collector tab portion 412 are disposed only on one surface of the positive-electrode current collector foil 41.

### EXPLANATION OF REFERENCE NUMERALS

1: lithium-ion secondary battery

10: stacked body

20: negative electrode

30: electrolyte

40: positive electrode

41: positive-electrode current collector foil

410: positive-electrode active material layer forming portion

411: current-collector exposed portion

412: current-collector tab portion

42: positive-electrode active material layer

50: separator

60, 160: insulating member

What is claimed is:

1. A lithium-ion secondary battery, comprising:
a stacked body in which a negative electrode including lithium and a positive electrode are stacked with an electrolyte therebetween,
wherein the positive electrode includes a positive-electrode current collector foil and a positive-electrode active material layer stacked on the positive-electrode current collector foil,
the positive-electrode current collector foil includes:
a positive-electrode active material layer forming portion in which the positive-electrode active material layer is formed;
a current-collector exposed portion adjacent to the positive-electrode active material layer forming portion and having a surface of the positive-electrode current collector foil exposed; and
a current-collector tab portion disposed on a side opposite to the positive-electrode active material layer forming portion across the current-collector exposed portion and located at an end portion of the positive-electrode current collector foil, and
an insulating member is disposed so as to cover a surface and an end portion of the current-collector exposed portion.

2. The lithium-ion secondary battery according to claim 1, further comprising:
a separator disposed between the negative electrode and the positive electrode,
wherein, in a predetermined direction in which the current-collector tab portion, the current-collector exposed portion, and the positive-electrode active material layer forming portion are arranged, when a side of the current-collector tab portion of the positive-electrode current collector foil is defined as an outer side, and a side of the positive-electrode active material layer forming portion is defined as an inner side,
an outer end portion of the insulating member in the predetermined direction is positioned farther outward than an outer end portion of the separator and positioned farther inward than an end portion of the current-collector tab portion on a side opposite to the positive-electrode active material layer forming portion.

3. The lithium-ion secondary battery according to claim 1, further comprising:
a separator disposed between the negative electrode and the positive electrode,
wherein, in a predetermined direction in which the current-collector tab portion, the current-collector exposed portion, and the positive-electrode active material layer forming portion are arranged, when a side of the current-collector tab portion of the positive-electrode current collector foil is defined as an outer side, and a side of the positive-electrode active material layer forming portion is defined as an inner side,
the current-collector exposed portion is disposed farther inward than an outer end portion of the separator in the predetermined direction and has a width equal to a width of the positive-electrode active material layer forming portion.

4. The lithium-ion secondary battery according to claim 1, wherein a volume resistivity of the insulating member is 1×10¹⁵ Ω cm or more.

5. The lithium-ion secondary battery according to claim 1, wherein a volume resistivity of the insulating member is 1×10²⁰ Ω cm or less.

6. The lithium-ion secondary battery according to claim 1, wherein a thickness of the insulating member is between 5µm and 100 µm inclusive.

7. The lithium-ion secondary battery according to claim 1, wherein the positive-electrode current collector foil is a composite current-collector foil.

8. The lithium-ion secondary battery according to claim 1, wherein the insulating member has heat-resistant adhesiveness.

9. The lithium-ion secondary battery according to claim 1, wherein the insulating member has thermal fusibility.

10. The lithium-ion secondary battery according to claim 1, further comprising:
a separator disposed between the negative electrode and the positive electrode,
wherein a conductive layer is formed on a side of the negative electrode of the separator.
